(19) United States
(12) Patent Application Publication
(10) Pub. No.: US 2026/0225424 A1
(43) Pub. Date: Aug. 6, 2026

(54) Temperature Control Device for the Temperature Control of at Least One Portion of a Motor Vehicle

(71) Applicant: Bayerische Motoren Werke Aktiengesellschaft, Muenchen (DE)

(72) Inventor: Sebastian HAHN, Schwertberg (AT)

(21) Appl. No.: 19/149,969

(22) PCT Filed: Mar. 19, 2024
(86) PCT No.: PCT/EP2024/057244

§ 371 Date: Jul. 22, 2025

(30) Foreign Application Priority Data
Apr. 25, 2023 (DE) 10 2023 110 463.2

(51) Int. Cl. B60H 1/00; B60H 1/32

(52) U.S. Cl. CPC B60H 1/00492; B60H 1/00885; B60H 1/3227; B60H 1/3228

(57) ABSTRACT

The invention relates to a temperature control device for controlling the temperature of a motor vehicle, comprising a refrigerant circuit through which a refrigerant flows, including: a compressor section including a refrigerant compressor configured to convey and compress the refrigerant; and a condenser section connected in series with the compressor section and through which a first partial mass flow of the refrigerant can flow, in which a first expansion valve is configured to expand the first partial mass flow, and a condenser configured to condense the first partial mass flow. A bypass section of the circuit, connected in parallel with the condenser section and in series with the compressor section and through which a second partial mass flow of the refrigerant can flow, in which bypass section a second expansion valve, by means of which the second partial mass flow can be set and expanded, is located.

### BACKGROUND AND SUMMARY

The invention relates to a temperature control device for the temperature control of at least one portion of a motor vehicle. Furthermore, the invention relates to a method for operating such a temperature control device. The invention also relates to a motor vehicle comprising at least one such temperature control device.

JP 5861 495 B2 discloses a temperature control device for a vehicle. Furthermore, EP 2 265 453 B1 discloses a cooling arrangement for cooling a temperature-sensitive unit of a motor vehicle. DE 60320 060 T2 also discloses a method for operating a cooling system.

An object of the present invention is to provide a temperature control device for the temperature control of at least one portion of a motor vehicle, a method for operating such a temperature control device and a motor vehicle with at least one such temperature control device, so that particularly efficient operation of the temperature control device can be realized.

According to the invention, this object is achieved by a temperature control device, a method, and by a motor vehicle as recited in the independent claims. Advantageous embodiments and implementations of the invention are the subject of the dependent claims.

A first aspect of the invention relates to a temperature control device for the temperature control, i.e., for cooling and/or heating at least one portion of a motor vehicle, also referred to simply as a vehicle. This means that the motor vehicle, which is also referred to simply as a vehicle and is preferably designed as a motor vehicle, in particular as a passenger car, has the temperature control device in its completely manufactured state, by means of which at least the partial region can be temperature-controlled, that is to say cooled and/or heated. In particular, it is provided that, in a method for operating the temperature control device, at least the portion of the motor vehicle is temperature-controlled, i.e., cooled and/or heated, by means of the temperature control device. For example, the portion is or comprises an interior of the motor vehicle, also referred to as the passenger compartment or passenger area, in the interior of which persons, such as the driver of the motor vehicle, can be present while the motor vehicle is being driven. Alternatively or additionally, the portion may, for example, comprise an electrical energy storage unit of the motor vehicle. Preferably, the electrical energy storage device, in or by means of which electrical energy, in particular electrochemical energy, can be stored or is stored, is a high-voltage component of which the electrical voltage, in particular electrical operating or rated voltage, is preferably greater than 50 volts, in particular greater than 60 volts, and very preferably is several hundred volts. The motor vehicle is therefore, for example, a hybrid vehicle or an electric vehicle, in particular a battery electric vehicle (BEV). The motor vehicle has, for example, at least one electric machine by means of which the motor vehicle can be driven, in particular purely, electrically. Preferably, the electric machine is a high-voltage component of which the electrical voltage, in particular electrical operating or rated voltage, is preferably greater than 50 volts, in particular preferably greater than 60 volts, and very preferably is several hundred volts. For example, the electric machine can be supplied with the electrical energy stored in the electrical energy storage device, whereby the electric machine can be operated in a motor mode and thus as an electric motor, by means of which the motor vehicle can be driven, in particular purely, electrically.

The temperature control device has a refrigerant circuit, also known simply as a circuit or refrigerant circuit, through which a refrigerant can flow and, in particular, through which it flows during the process. The refrigerant circuit has a compressor section, also referred to as the compressor branch, which is also referred to as the first section or first branch. The refrigerant can flow or flows through the compressor section. The refrigerant circuit also has a refrigerant compressor, also known as a compressor, which is arranged in the compressor section. The refrigerant is conveyed and compressed by means of the refrigerant compressor. In other words, the refrigerant compressor can convey and compress the refrigerant. Thus, for example, it is provided in the method that the refrigerant is conveyed and compressed by means of the refrigerant compressor.

The refrigerant circuit also has a condenser section, which is connected fluidically in series with the compressor section and through which a first partial mass flow of the refrigerant can flow, which is also referred to as the second section or second branch. For example, the condenser section branches off from the compressor section, in particular at a first branch point. A first expansion valve is arranged in the condenser section, by means of which the first partial mass flow can be adjusted and expanded. Thus, for example, the method provides for the first partial mass flow to be expanded by means of the first expansion valve. The first expansion valve can thus be used to set several different values of the first partial mass flow rate, so that the first partial mass flow rate can be varied. In addition, a condenser is arranged in the condenser section, by means of which the first partial mass flow can be condensed, in particular in a targeted manner. Thus, for example, the method provides for the first partial mass flow to be condensed, in particular in a targeted manner, by means of the condenser. By condensing the first partial mass flow, the first partial mass flow is or becomes cooled or cooled.

The refrigerant circuit also has a bypass section, which is fluidically connected in series to the compressor section and in parallel to the condenser section and through which a second partial mass flow of the refrigerant can flow. The bypass section is also referred to as the third section or third branch. Thus, for example, it is provided in the process that the second partial mass flow flows through the bypass section. For example, the bypass section branches off from the compressor section, in particular at a second branch point. The branch points may coincide and thus be formed by a single overall branch point or be located at a single overall branch point, or the branch points may be spaced apart, in particular in the direction of flow of the refrigerant flowing through the refrigerant circuit. In particular, for example, it is provided in the method that the second partial mass flow flows through the bypass section. A second expansion valve is arranged in the bypass section, by means of which the second partial mass flow can be adjusted and expanded. Thus, it is provided in particular in the method that the second partial mass flow is expanded by means of the second expansion valve. The feature that the second partial mass flow is adjustable by means of the second expansion valve is to be understood in particular as meaning that a plurality of mutually different values of the second partial mass flow are adjustable by means of the second expansion valve, whereby the second partial mass flow is variable, i.e., changeable. The first partial mass flow rate or the second partial mass flow rate can be adjusted by the respective first or second expansion valve in particular in that a respective flow cross-section of the respective expansion valve through which the first or second partial mass flow rate can flow can be adjusted, i.e., different values of the respective flow cross-section can be set.

The first expansion valve is or can be passed through or is passed through by the first partial mass flow, and the second expansion valve is or can be passed through or is passed through by the second partial mass flow. The refrigerant compressor and thus, for example, the compressor section, i.e., at least one portion of the compressor section, are or can be passed through or are passed through, for example, by a compressor flow formed by the refrigerant, which is a mass flow of the refrigerant. The compressor flow comprises at least the first partial mass flow and the second partial mass flow and is thus formed at least by the first partial mass flow and by the second partial mass flow. In addition, the second partial mass flow can or does flow through the condenser. The condenser is, for example, a heat exchanger which can be operated or is operated or functions as the condenser, for example, at least in one operation, in particular at least in a heat pump operation, of the temperature control device. For example, a fluid provided in addition to the refrigerant can flow through and/or around the condenser. For example, heat can be transferred from the refrigerant to the fluid via the condenser, whereby the refrigerant is cooled and the fluid is heated, in particular in the aforementioned operation. In this way, heat contained in the refrigerant can be used to heat the fluid. The fluid can, for example, be supplied to the portion in order thereby to heat the portion by means of the fluid, in particular by means of the heat that has been transferred from the refrigerant to the fluid via the condenser, and thereby to control the temperature. In more general terms, for example, the portion can be tempered, in particular heated, by means of the fluid, in particular by means of the heat contained in the fluid, which has been transferred from the refrigerant to or onto the fluid via the condenser. For example, the fluid is a gas, in particular air, which is or can be introduced into the portion, in particular into the interior, in order to thereby temper, in particular heat, the interior by means of the fluid. It is also conceivable that the fluid is a liquid. For example, the electrical energy storage device can be tempered, in particular heated, by means of the fluid. For this purpose, the electrical energy storage device is supplied with the fluid, for example. In particular, the operation mentioned is, for example, a heat pump operation.

The heat that is transferred from the refrigerant to the fluid via the condenser can, for example, be transferred from the fluid to the electrical energy store in order to heat and thus control the temperature of the electrical energy store. The aforementioned heat, which can be transferred or is transferred from the refrigerant onto or to the fluid via the condenser, comes at least predominantly or exclusively from the refrigerant compressor, for example, or is at least predominantly or exclusively caused by the refrigerant compressor or fed into the refrigerant, in particular by the refrigerant compressor compressing the refrigerant and thus heating it. The refrigerant compressor can thus be used as a heating source to heat the refrigerant and, in particular via the condenser, for example the fluid and subsequently to heat the portion.

Furthermore, it is provided that the bypass section and the condenser section are brought together at, in particular exactly, one mixing point and are thereby fluidically connected to one another. At the mixing point, the first partial mass flow and the second partial mass flow can be or are brought together to form a total mass flow, and at the mixing point, the first partial mass flow and the second partial mass flow are or are to be mixed or blended with one another, in that the first partial mass flow and the second partial mass flow can be or are brought together at the mixing point to form the total mass flow. Thus, the compressor flow passing through the refrigerant compressor comprises at least or exclusively the total mass flow. In particular, it is conceivable that in a first operating state of the temperature control device, the compressor flow comprises exclusively the total mass flow, i.e., exclusively the first partial mass flow and the second partial mass flow, and is thus formed exclusively by the total mass flow. In a second operating state of the temperature control device, the compressor flow comprises, for example, in particular exclusively, the total mass flow and at least or exactly one further partial mass flow of the refrigerant, so that in the second operating state the compressor flow is formed, in particular exclusively, by the first partial mass flow, the second partial mass flow and the at least or exactly one further partial mass flow of the refrigerant. Due to the fact that the first partial mass flow and the second partial mass flow are or can be brought together at the mixing point and thereby mixed with each other, the first partial mass flow and the second partial mass flow form or result in the total mass flow, which can, for example, be introduced into the compressor section and thus flow in and subsequently flow through the compressor section and, in particular, the refrigerant compressor. Since the first partial mass flow and the second partial mass flow result in or form the total mass flow because the first partial mass flow and the second partial mass flow are combined and thus mixed with each other, the first partial mass flow and the second partial mass flow are each lower than the total mass flow and the compressor flow when considered individually. In addition, the further partial mass flow, considered on its own, is lower than the compressor flow and, for example, than the total mass flow.

For example, it is intended that the first partial mass flow branches off from the compressor flow or from a further mass flow of refrigerant branched off from the compressor flow at the first branch point. Furthermore, it is intended, for example, that the second partial mass flow branches off from the compressor flow or from the further mass flow, particularly at the second branch point. If the branch points coincide, it is conceivable that the compressor flow or the further mass flow branches off at the overall branch point into the first partial mass flow and the second partial mass flow, i.e., is split.

In the method for operating the temperature control device, for example, a first pressure and a first temperature of the refrigerant, in particular of the compressor flow flowing through the refrigerant compressor, in the compressor section upstream of the refrigerant compressor and downstream of the mixing point are determined by means of an electronic computing device, in particular of the temperature control device, in particular of the motor vehicle. The first pressure of the refrigerant, in particular of the compressor flow, is to be understood as a pressure of the refrigerant, in particular of the compressor flow, with the first pressure prevailing at a first pressure point, which is arranged in the compressor section upstream of the refrigerant compressor and downstream of the mixing point. The first temperature of the refrigerant, in particular of the compressor flow, is to be understood as a temperature of the refrigerant, in particular of the compressor flow, wherein the first temperature prevails at a first temperature point which is arranged in the compressor section upstream of the refrigerant compressor and downstream of the mixing point. For example, the first pressure point and the first temperature point coincide.

The electronic computing device is used to determine a second pressure and a second temperature of the refrigerant downstream of the refrigerant compressor, upstream of the condenser and upstream of the expansion valves. The second pressure of the refrigerant is to be understood as a pressure of the refrigerant, wherein the second pressure prevails at a second pressure point, which is arranged downstream of the refrigerant compressor and upstream of the condenser and upstream of the expansion valves, wherein the second pressure point is arranged, for example, in the compressor section or in the bypass section or in the condenser section. Thus, for example, the second pressure is a second pressure of the compressor flow flowing through the refrigerant compressor, which has the second pressure downstream of the refrigerant compressor and upstream of the condenser and upstream of the expansion valves, in particular in the compressor section and in particular upstream of the branch points. When the expansion valves are referred to above and in the following, this means the first expansion valve and the second expansion valve, unless otherwise specified. The second temperature of the refrigerant is to be understood as a temperature of the refrigerant, wherein the second temperature prevails at a second temperature point which is arranged downstream of the refrigerant compressor, upstream of the condenser and upstream of the expansion valves, wherein the second temperature point is arranged in the compressor section, in the bypass section or in the condenser section. In particular, it is conceivable that the second pressure point and the second temperature point coincide. Thus, for example, the second temperature is a second temperature of the compressor flow flowing through the refrigerant compressor, which has the second temperature downstream of the refrigerant compressor and upstream of the condenser and upstream of the expansion valves, in particular in the compressor section and, in particular, upstream of the branch points.

The electronic computing device is used to determine a third pressure and a third temperature of the refrigerant, in particular of the first partial mass flow, in the condenser section downstream of the condenser and upstream of the first expansion valve. The third pressure of the refrigerant, in particular of the first partial mass flow, is to be understood as a pressure of the refrigerant, in particular of the first partial mass flow, wherein the third pressure prevails at a third pressure point, which is arranged in the condenser section downstream of the condenser and upstream of the first expansion valve. The third temperature of the refrigerant, in particular of the first partial mass flow, is to be understood as a temperature of the refrigerant, in particular of the first partial mass flow, the third temperature prevailing at a third temperature point which is arranged in the condenser section downstream of the condenser and upstream of the first expansion valve. The third pressure point and the third temperature point can coincide.

As described above, the compressor flow can flow through the refrigerant compressor so that, for example, the compressor flow flows through the refrigerant compressor and thus, for example, at least through part of the compressor section during the process. The pressures and temperatures are determined using the electronic computing device, which will be explained in more detail below.

In the method, the expansion valves are controlled by means of the electronic computing device as a function of the determined temperatures and as a function of the determined pressures, whereby the first partial mass flow rate and the second partial mass flow rate are set as a function of the determined temperatures and as a function of the determined pressures. When the partial mass flow rates are referred to above and in the following, this means the first partial mass flow rate and the second partial mass flow rate, unless otherwise specified. This means that by means of the electronic computing device via the expansion valves, i.e., by controlling the expansion valves, the partial mass flows are set, i.e., in particular varied, as a function of the determined pressures and as a function of the determined temperatures, for example by setting, i.e., in particular varying, the flow cross-sections of the expansion valves by controlling the expansion valves. In this way, a ratio between the partial mass flows, also referred to as a mixing ratio, in particular a ratio of the first partial mass flow to the second partial mass flow, can be set in a particularly advantageous manner, so that robust operation of the temperature control device and, as a result, effective and efficient temperature control can be achieved. In particular, by adjusting the first partial mass flow rate and the second partial mass flow rate and thus by adjusting the mixing ratio, it is possible to prevent the refrigerant compressor from being supplied with wet vapor or even liquid. In other words, it can be avoided, for example, that the compressor stream flowing through the compressor section and comprising at least the first partial mass flow and the second partial mass flow, which results from the mixing of at least the first partial mass flow with the second partial mass flow, comprises wet vapor or even liquid, so that undesirable damage to the temperature control device can be avoided. Furthermore, it is possible to realize a particularly advantageous temperature control of the portion without an electric flow heater being arranged in the refrigerant circuit or in an additional temperature control circuit provided for temperature control of the portion and through which, for example, the fluid can flow. Furthermore, there is no need for a heat exchanger, also known as a chiller, which is arranged in the refrigerant circuit and, for example, in the temperature control circuit and can be operated or operated as an evaporator, so that the number of parts and thus the weight and costs of the temperature control device can be kept particularly low. At the same time, it is possible to adjust the partial mass flows and thus the mixing ratio in such an advantageous way that the total mass flow has a particularly advantageous state, in particular an aggregate state, in particular such that, for example, the enthalpy of the total mass flow is to the right of the saturated vapor line of the refrigerant, which is in the form of R1234yf, for example, in particular in a phase diagram of the refrigerant, wherein, for example, the enthalpy, in particular the specific enthalpy, is plotted on the abscissa of the phase diagram, and wherein the pressure of the refrigerant, in particular logarithmically, is plotted on the ordinate of the phase diagram.

In order to achieve particularly efficient operation of the temperature control device, in particular the refrigerant compressor, the temperature control device has a heat accumulator designed to store heat. In other words, heat can be stored by means of the heat accumulator, i.e., in the heat accumulator. In particular, this means that heat can either be stored in the heat accumulator and thus stored in the heat accumulator or the heat accumulator can release heat stored in the heat accumulator. The heat accumulator has an inlet region via which the refrigerant can be supplied to the heat accumulator, so that heat from the refrigerant supplied to the heat accumulator via the inlet region can be stored in the heat accumulator or heat stored in the heat accumulator can be transferred from the heat accumulator to the refrigerant supplied to the heat accumulator via the inlet region. In particular, the refrigerant supplied to the heat accumulator via the inlet region can flow through the heat accumulator, so that heat from the refrigerant supplied to the heat accumulator via the inlet region and flowing through the heat accumulator can be stored in the heat accumulator or heat stored in the heat accumulator can be transferred from the heat accumulator to the refrigerant supplied to the heat accumulator via the inlet region and flowing through the heat accumulator.

Furthermore, the thermal accumulator has an outlet region via which the refrigerant supplied to the thermal accumulator via the inlet region and flowing through the thermal accumulator can be discharged from the thermal accumulator, i.e., in particular can be discharged from the thermal accumulator, after the refrigerant has been supplied to the thermal accumulator via the inlet region. This means, for example, that the refrigerant can flow through the heat accumulator in such a way that the refrigerant can flow from the inlet region to the outlet region and thereby flow through the heat accumulator. In other words, the refrigerant flows from the inlet region to the outlet region on its way through the heat accumulator. The outlet region is thus arranged downstream of the inlet region. Thus, for example, it is provided in the method that, in particular in the aforementioned operation, the refrigerant is supplied to the thermal accumulator via the inlet region, so that the refrigerant flows into the thermal accumulator via the inlet region, flows through the thermal accumulator and thereby flows from the inlet region to the outlet region and flows out of the thermal accumulator via the outlet region, and is thus discharged from the thermal accumulator. Between the refrigerant flowing through the thermal accumulator and thereby flowing from the inlet region to the outlet region and the thermal accumulator, i.e., for example between the refrigerant flowing through the thermal accumulator and thereby flowing from the inlet region to the outlet region and at least one storage element of the thermal accumulator, heat can be or is exchanged, in particular while the refrigerant flows through the heat accumulator, so that heat is either transferred from the refrigerant flowing through the heat accumulator to the heat accumulator or heat is transferred from the heat accumulator to the refrigerant flowing through the heat accumulator. If heat is transferred from the refrigerant flowing through the heat accumulator to the heat accumulator, the heat that is transferred from the refrigerant to the heat accumulator is stored in the heat accumulator and thus stored in the heat accumulator. This cools the refrigerant. If heat is transferred from the heat accumulator to or onto the refrigerant flowing through the heat accumulator, the refrigerant is heated and heat is removed from the heat accumulator.

Quite preferably, the first expansion valve is arranged in the condenser section downstream of the condenser and, in particular, upstream of the mixing point. Furthermore, the temperature control device has a valve device that can be switched between a first switching state and a second switching state. In particular, the valve device can be switched between the first switching state and the second switching state by activating the valve device. For example, the valve device can be actuated by supplying the valve device with electrical energy. In other words, the valve device can be controlled by supplying the valve device with electrical energy. In the first switching state, the heat accumulator is connected to the refrigerant circuit by means of the valve device in such a way that in the first switching state the heat accumulator is fluidically connected to the refrigerant circuit at a point downstream of the refrigerant compressor, upstream of the condenser section and upstream of the bypass section in the refrigerant circuit, in particular in the compressor section, and at a second connection point, which is located upstream of the refrigerant compressor in the refrigerant circuit, in particular in the compressor section, which is located in the refrigerant circuit, in particular in the compressor section, downstream of the first expansion valve and/or downstream of the second expansion valve, whereby in the first switching state at least one portion of the refrigerant compressed by means of the refrigerant compressor can be fed to the heat accumulator from the first connection point via the inlet region and the refrigerant discharged from the heat accumulator via the outlet region can be introduced into the refrigerant circuit at the second connection point. Thus, for example, in the first switching state, the thermal accumulator is connected to the refrigerant circuit by means of the valve device in such a way that the thermal accumulator is connected fluidically parallel to the bypass section and fluidically parallel to the condenser section and fluidically in series with the compressor section, in particular in such a way that at least some of the refrigerant compressed by the refrigerant compressor can be fed to the thermal accumulator via the inlet region. Thus, for example, in the first switching state, a third partial mass flow of the refrigerant from the first connection point can be fed to the thermal accumulator via the inlet region, wherein the third partial mass flow is formed by a portion of the refrigerant compressed by the refrigerant compressor. The third partial mass flow is therefore the aforementioned portion of the refrigerant compressed by the refrigerant compressor, which can be fed to the thermal accumulator via the inlet region in the first switching state. In particular, it is conceivable that the third partial mass flow is discharged from the heat accumulator via the outlet region and introduced into the refrigerant circuit at the second connection point. In particular, the third partial mass flow is the aforementioned further partial mass flow, so that, for example, in the first switching state the compressor flow comprises, for example, in particular exclusively, the total mass flow and at least or exactly the third partial mass flow of the refrigerant, so that in the first switching state the compressor flow is formed, in particular exclusively, by the first partial mass flow, the second partial mass flow and the third partial mass flow of the refrigerant. Thus, for example, it can be provided that the valve device is in the first switching state in the aforementioned second operating state.

In particular, the second connection point can coincide with the mixing point, or the second connection point is arranged downstream of the mixing point, in particular in the compressor section. It is also conceivable that the second connection point is arranged upstream of the mixing point and in the condenser section or in the bypass section. The first connection point can, for example, coincide with the first branch point and/or with the second branch point and/or with the overall branch point, or the first connection point is at a distance from the first branch point and/or from the second branch point and/or from the overall branch point. In particular, it may be provided that in the first switching state at the first connection point, the compressor flow branches off into the first partial mass flow, the second partial mass flow and the third partial mass flow, or in the first switching state, for example, the compressor flow at the first connection point branches off into the third partial mass flow and the further mass flow, which then branches off into the first partial mass flow and the second partial mass flow, for example, at the total branch point.

In the second switching state, the heat accumulator is connected to the refrigerant circuit by means of the valve device in such a way that in the second switching state, the heat accumulator is fluidically connected to the refrigerant circuit at a third connection point, which is arranged upstream of the refrigerant compressor in the refrigerant circuit, in particular in the compressor section, which is arranged in the refrigerant circuit downstream of the first expansion valve and/or downstream of the second expansion valve. The third connection point can coincide with the mixing point, or the third connection point is preferably arranged downstream of the mixing point.

In the second switching state, the thermal accumulator is connected to the refrigerant circuit by means of the valve device in such a way that in the second switching state the thermal accumulator is fluidically connected to the refrigerant circuit at a fourth connection point arranged downstream of the third connection point and upstream of the refrigerant compressor in the refrigerant circuit, in particular in the compressor section, whereby, in the second switching state, at least one portion of the total mass flow, in particular the entire mass flow, can be fed to the heat accumulator via the inlet region of the third connection point and the refrigerant discharged from the heat accumulator via the outlet region can be introduced into the refrigerant circuit at the fourth connection point. In particular, it is intended that the total mass flow, especially the entire mass flow, can flow through the third connection point.

Thus, for example, in the second switching state, the heat accumulator is connected to the refrigerant circuit by means of the valve device in such a way that the heat accumulator is connected in series with the bypass section, in series with the condenser section and in series with the refrigerant compressor, in particular in such a way that the heat accumulator is arranged downstream of the condenser section, downstream of the bypass section and upstream of the refrigerant compressor. Thus, for example, in the second switching state, the compressor flow flowing through the refrigerant compressor comprises, in particular exclusively, the total mass flow, so that in the second switching state the compressor flow is formed, in particular exclusively, by the first partial mass flow and the second partial mass flow of the refrigerant. Thus, for example, it can be provided that the valve device is in the second switching state in the aforementioned first operating state.

Since the refrigerant compressor compresses the refrigerant and thereby heats it, the refrigerant compressed and thereby heated by the refrigerant compressor can, for example, be fed to the heat accumulator in the first switching state, in particular in the form of the third partial mass flow, so that heat can be transferred from the refrigerant to the heat accumulator and thus stored in the heat accumulator. Thus, in the first switching state, the heat accumulator is fluidically connected via the inlet region or the inlet region to a high-pressure side of the refrigerant compressor, also known as the high-pressure area, wherein the refrigerant compressor provides the refrigerant compressed by means of the refrigerant compressor on or via its high-pressure side. In the second switching state, the refrigerant expanded by means of the first expansion valve and/or by means of the second expansion valve can be supplied to the heat accumulator via the inlet region, in particular in the form of the total mass flow, since in the second switching state the heat accumulator is fluidically connected to the refrigerant circuit via the inlet region or the inlet region at the third connection point. Thus, in the second switching state, the heat accumulator is fluidically connected to a low-pressure side of the refrigerant compressor, also known as the low-pressure area, via the inlet region or the inlet region. Thus, for example, in the second switching state, heat can be transferred from the heat accumulator to or onto the refrigerant flowing through the heat accumulator, in particular to or onto the total mass flow or compressor flow, whereby the refrigerant is heated before the refrigerant flows through the refrigerant compressor. Since the fourth connection point is arranged downstream of the third connection point and upstream of the refrigerant compressor, the refrigerant compressor is supplied with the refrigerant, which is or was heated by means of the heat accumulator and thus by the fact that heat is transferred from or to the refrigerant from the heat accumulator. The invention thus enables particularly efficient operation of the temperature control device. In particular, the invention makes it possible, by using the heat accumulator, to operate the refrigerant compressor with such, in particular electrical, power of the refrigerant compressor that the refrigerant compressor can be operated at an efficiency-favorable operating point, in particular independently of a power requirement of the condenser, that is, for example, independently of a power with which the condenser is operated or supplied.

If, for example, in the second operating state of the temperature control device, the condenser is operated or supplied with such a capacity that the refrigerant compressor would have to be operated with a capacity of, for example, two kilowatts without using the heat accumulator, by using the heat accumulator and in the first switching state of the valve device, the refrigerant compressor can now be operated with a capacity of more than two kilowatts and thus much more efficiently, i.e., more efficiently, because excess capacity of the refrigerant compressor, the excess capacity of which is not required to operate the condenser, can now be stored as heat in the heat accumulator. This makes it possible, for example, to operate the refrigerant compressor in the second operating state not with two kilowatts, but with a capacity of six kilowatts, for example. Two of these six kilowatts of refrigerant compressor power can be used to operate the condenser, and the remaining four kilowatts of refrigerant compressor power can be used to store heat in the heat accumulator. The heat stored in the heat accumulator can then be used later, for example in the first operating state, in order to enable particularly efficient operation of the refrigerant compressor in the first operating state as well.

If, for example, the condenser is operated or supplied with such a power in the first operating state of the temperature control device that the refrigerant compressor would have to be operated with a power of nine kilowatts, for example, without using the heat accumulator, the refrigerant compressor can now be operated with a power of less than nine kilowatts by using the heat accumulator and in the second switching state of the valve device and thus much more efficiently, and therefore more effectively, because the heat stored in the heat accumulator can be used to heat the refrigerant. The refrigerant can therefore be heated in the second switching state and thus, for example, in the first operating state both by means of the refrigerant compressor and by means of heat from the heat accumulator. In other words, the heat accumulator, i.e., the heat stored in the heat accumulator, which was stored in the heat accumulator in the second operating state, for example, can support the refrigerant compressor in heating the refrigerant in the first operating state. This makes it possible, for example, to operate the refrigerant compressor in the first operating state not with nine kilowatts, but with a capacity of, for example, six kilowatts. The power of three kilowatts missing for operating the condenser is compensated or provided, for example, by transferring heat from the heat accumulator to the refrigerant. As a result, the refrigerant has such a high heat level before it is compressed by the refrigerant compressor that a capacity of six kilowatts of the refrigerant compressor is sufficient to compress and heat the refrigerant from the heat level by means of the refrigerant compressor in such a way that the compressed refrigerant downstream of the refrigerant compressor, upstream of the bypass section and upstream of the condenser section has such a temperature that the refrigerant would have if the heat accumulator were not used and, in particular alone, i.e., without the heat accumulator, the refrigerant compressor would compress the refrigerant with a capacity of nine kilowatts. It can be seen that in both operating states, the refrigerant compressor could be operated at six kilowatts, for example, and thus particularly efficiently, so that particularly efficient and effective operation of the temperature control device can be achieved.

Furthermore, it can be seen that in the first switching state and in the second switching state, the refrigerant compressor can convey the refrigerant, in particular via the inlet region, to the heat accumulator and, in particular via the outlet region, away from the heat accumulator and, in particular, can convey it through the heat accumulator.

In order to achieve particularly efficient operation of the temperature control device, one embodiment of the invention provides for the heat accumulator to be designed as a latent heat accumulator, which is also referred to as a phase change memory or PCM memory (PCM—phase change material). The latent heat accumulator has at least one phase change material for storing the heat. The phase change material is therefore, for example, the aforementioned storage element.

To achieve particularly efficient operation, it has been shown to be particularly advantageous if the phase change material has a melting temperature in the range from 50 degrees Celsius up to 90 degrees Celsius, inclusive in each case.

In order to be able to realize a particularly efficient operation, it is provided in a further embodiment of the invention that the melting temperature of the phase change material is in a range from 75 degrees Celsius up to 90 degrees Celsius, inclusive in each case.

In a further, particularly advantageous embodiment of the invention, it is provided that the melting temperature is in a range from 75 degrees Celsius up to 80 degrees Celsius, inclusive in each case. This ensures particularly efficient operation.

A further embodiment is distinguished in that the melting temperature of the phase change material is in a range from 50 degrees Celsius up to 80 degrees Celsius, inclusive in each case. This enables particularly effective and therefore efficient operation of the temperature control device.

In order to be able to operate the temperature control device particularly efficiently and thus with a favorable degree of efficiency, it is provided in a further embodiment of the invention that the temperature control device has a third expansion valve which is provided in particular in addition to the first expansion valve and in addition to the second expansion valve, which in the first switching state, preferably in relation to the switching states exclusively in the first switching state, is connected in series to the heat accumulator in such a way that in the first switching state the third expansion valve is arranged downstream of the first connection point and upstream of the second connection point. By means of the third expansion valve, the aforementioned third partial mass flow of refrigerant flowing through the thermal accumulator in the first switching state can be adjusted and expanded. The previous and following explanations regarding the first expansion valve and the second expansion valve can also be readily transferred to the third expansion valve and vice versa.

In order to be able to realize a particularly effective and thus efficient operation of the temperature control device, it is provided in a further embodiment of the invention that in the first switching state the third expansion valve is connected in series to the thermal accumulator in such a way that in the first switching state the third expansion valve is arranged downstream of the thermal accumulator and upstream of the second connection point.

A second aspect of the invention relates to a method of operating a temperature control device according to the first aspect of the invention. Advantages and advantageous embodiments of the first aspect of the invention are to be regarded as advantages and advantageous embodiments of the second aspect of the invention, and vice versa.

A third aspect of the invention relates to a motor vehicle, also simply referred to as a vehicle and preferably designed as a motor vehicle, in particular as a passenger car, which has at least one temperature control device according to the first aspect of the invention.

### BRIEF DESCRIPTION OF THE DRAWINGS

Further details of the invention can be seen from the following description of an exemplary embodiment with the associated drawings, in which:

FIG. 1 shows a schematic representation of a temperature control device for temperature control of at least one portion of a motor vehicle;

FIG. 2 shows a phase diagram of a refrigerant containing a refrigerant circuit of the temperature control device in a method for operating the temperature control device;

FIG. 3 shows a schematic representation of the temperature control device, wherein a valve device of the temperature control device is in a first switching state; and

FIG. 4 shows a schematic representation of the temperature control device, wherein the valve device is in a second switching state.

In the figures, like or functionally like elements are provided with the same reference signs.

### DETAILED DESCRIPTION OF THE DRAWINGS

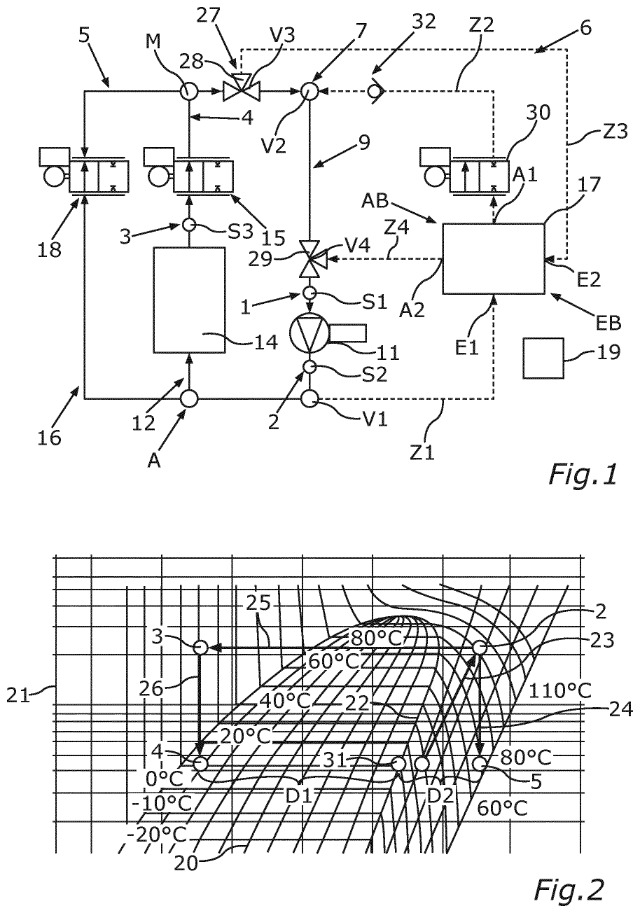

FIG. 1 shows a schematic representation of a temperature control device 6 of a motor vehicle, also simply referred to as a vehicle and preferably designed as a motor vehicle, in particular as a passenger car. In particular, a method for operating the temperature control device 6 is described with reference to figure. By means of the temperature control device 6, at least one portion of the motor vehicle can be temperature-controlled, i.e., heated or cooled. In particular, the portion can be heated. For example, the portion is or comprises an interior of the motor vehicle, also known as the passenger cell or passenger compartment, of which the structure, for example in the form of a self-supporting body, forms or delimits the interior. The interior can therefore be temperature-controlled, in particular heated, using the temperature control device 6, for example. For this purpose, the temperature control device 6 has a refrigerant circuit 7 through which a refrigerant can flow and through which the refrigerant flows during the method and thus during operation of the temperature control device 6, which is operated according to the method.

The refrigerant circuit 7 has a compressor section 9 through which the refrigerant can flow. A refrigerant compressor 11 is arranged in the compressor section 9, by means of which the refrigerant can be conveyed and compressed. In the aforementioned operation and thus in the method, for example, the refrigerant is conveyed and compressed by means of the refrigerant compressor 11. In particular, a compressor flow formed by the refrigerant can flow through the refrigerant compressor 11 and thus at least a part of the compressor section 9, wherein the compressor flow is a mass flow of the refrigerant flowing through the refrigerant compressor 11. For example, the compressor flow is or comprises at least or exclusively a total mass flow of the refrigerant in the form of a mass flow of the refrigerant, which will be explained in more detail below.

The refrigerant circuit 7 has a condenser section 12 that is connected fluidically in series with the compressor section 9 and branches off from the compressor section 9 at a branch point A, allowing a first partial mass flow of refrigerant to flow through it. A condenser 14, also referred to as a liquefier, is arranged in the condenser section 12, by means of which the first partial mass flow, i.e., the refrigerant flowing through the condenser section 12, can be or is condensed, i.e., liquefied. In addition, a first expansion valve 15 is arranged in the condenser section 12 downstream of the condenser 14, by means of which the first partial mass flow can be adjusted. In addition, the first partial mass flow, i.e., the refrigerant flowing through the condenser section 12, can be or is expanded by means of the expansion valve 15.

The refrigerant circuit 7 also has a bypass section 16 which is connected fluidically in parallel to the condenser section 12 and in series to the compressor section 9 and which branches off from the compressor section 9 at branch point A, allowing a second partial mass flow of the refrigerant to flow through it. Since both the bypass section 16 and the condenser section 12 branch off from the compressor section 9 at the branch point A, the branch point A is an overall branch point.

A second expansion valve 18, which is provided in addition to the expansion valve 15 and by means of which the second partial mass flow can be adjusted, is arranged in the bypass section 16. Furthermore, the second partial mass flow, i.e., the refrigerant flowing through the bypass section 16, can be or is expanded by means of the expansion valve 18. Preferably, it is provided that during the process in the compressor section 9, in the condenser section 12 and in the bypass section 16, in particular in the entire refrigerant circuit 7, the refrigerant is not evaporated by means of an evaporator. The compressor section 9, the condenser section 12 and the bypass section 16 are also referred to as sections. In the design example shown in figure, the sections are free of an evaporator for targeted evaporation of the refrigerant.

The condenser section 12 and the bypass section 16 are brought together at, in particular exactly, one mixing point M of the refrigerant circuit 7, so that the first partial mass flow and the second partial mass flow can be brought together at the mixing point M to form the total mass flow and can thus be mixed with one another, and are thus brought together during the process and thus mixed or blended with one another. The total mass flow can be introduced into the compressor section 9, in particular from the mixing point M, and thus flow in and subsequently flow through the compressor section 9 and thus through the refrigerant compressor 11. In other words, the total mass flow can be fed to the refrigerant compressor 11, in particular starting from the mixing point M, and thus flow through the refrigerant compressor 11. Thus, the compressor flow is or comprises at least the total mass flow. In other words, it is conceivable that, at least in a first operating state of the temperature control device 6, the compressor flow comprises exclusively the total mass flow and is thus formed exclusively by the total mass flow. Furthermore, it is conceivable that, in particular in a second operating state of the temperature control device 6, the compressor flow comprises the total mass flow and at least or exactly one further partial mass flow of the refrigerant and is thus formed by the total mass flow and by the further partial mass flow of the refrigerant and in particular comprises exclusively the total mass flow and the further partial mass flow.

A first pressure and a first temperature of the refrigerant, in particular of the compressor flow, in the compressor section 9 upstream of the refrigerant compressor 11 and downstream of the mixing point M are determined by means of an electronic computing device 19, shown particularly schematically in FIG. 1. In the exemplary embodiment shown in FIG. 1, a first sensor device S1 is provided, by means of which the first pressure prevailing in the compressor section 9 upstream of the refrigerant compressor 11 and downstream of the mixing point M and the first temperature of the refrigerant, in particular of the compressor flow, prevailing in the compressor section 9 upstream of the refrigerant compressor 11 and downstream of the mixing point M are measured. The sensor device S1 provides, for example, a first signal characterizing the first temperature and the first pressure, which is received by the electronic computing device 19, whereby the electronic computing device 19 determines the first temperature and the first pressure. In FIG. 1, 1 denotes a first point, which is also referred to as the first digit. The first point 1 is arranged in the compressor section 9 downstream of the mixing point M and upstream of the refrigerant compressor 11, wherein, for example, the sensor device S1 measures the first pressure and the first temperature in or at the first point 1. In other words, for example, the first pressure and the first temperature of the refrigerant in the compressor section 9 prevail at point 1.

By means of the electronic computing device 19, a second pressure and a second temperature of the refrigerant, in particular of the compressor flow, downstream of the refrigerant compressor 11, upstream of the condenser 14 and upstream of the expansion valves 15 and 18 are determined in the process. In the exemplary embodiment shown in FIG. 1, a second sensor device S2 is provided, by means of which the second pressure of the refrigerant prevailing downstream of the refrigerant compressor 11, upstream of the condenser 14 and upstream of the expansion valves 15 and 18 and the second temperature of the refrigerant prevailing downstream of the refrigerant compressor 11, upstream of the condenser 14 and upstream of the expansion valves 15 and 18 are detected. The sensor device S2 provides, for example, a second signal which characterizes the second temperature and the second pressure. For example, the electronic computing device 19 receives the second signal, whereby the electronic computing device 19 determines the second pressure and the second temperature. In FIG. 1, a second point is labeled 2, wherein the second point is also referred to as the second digit. It can be seen that the first point 1 is located downstream of the mixing point M and upstream of the refrigerant compressor 11 in the compressor section 9. The second point 2 is arranged downstream of the refrigerant compressor 11, upstream of the condenser 14 and upstream of the expansion valves 15 and 18, wherein the second point 2 can be arranged at a branch point A or coincide with the branch point A, for example. The condenser section 12 and the bypass section 16 branch off from the compressor section 9 at branch point A. Here, for example, the second pressure and the second temperature prevail at or in the second point 2, with the second sensor device S2 measuring the second pressure and the second temperature in or at the second point 2, for example.

The electronic computing device 19 is used to determine a third pressure and a third temperature of the refrigerant, in particular of the first partial mass flow, in the condenser section 12 downstream of the condenser 14 and upstream of the first expansion valve 15, which is arranged in the condenser section 12 downstream of the condenser 14 and upstream of the mixing point M in the exemplary embodiment shown in FIG. 1. In the exemplary embodiment shown in FIG. 1, a third sensor device S3 is provided, by means of which the third pressure of the refrigerant prevailing in the condenser section 12 downstream of the condenser 14 and upstream of the first expansion valve 15 and the third temperature of the refrigerant prevailing in the condenser section 12 downstream of the condenser 14 and upstream of the expansion valve 15 are detected. For example, the third sensor device S3 provides a third signal that characterizes the third temperature and the third pressure. The electronic computing device 19 receives the third signal, for example, as a result of which the electronic computing device 19 determines the third temperature and the third pressure.

The expansion valves 15 and 18 are controlled by means of the electronic computing device 19 as a function of the determined temperatures and as a function of the determined pressures, whereby the first partial mass flow and the second partial mass flow are set as a function of the determined temperatures and as a function of the determined pressures. This sets a mixing ratio, also known as a mixing ratio, according to which the first partial mass flow and the second partial mass flow are mixed or blended together, resulting in the total mass flow. In particular, the mixing ratio is or describes a quotient, also referred to as a mixing quotient, wherein the mixing quotient has, for example, the first partial mass flow in its numerator and wherein the mixing quotient has, for example, the second partial mass flow in its denominator. The first partial mass flow is designated m1, for example, and the second partial mass flow is designated m2, for example. The mixing ratio is denoted by φ, for example. The following therefore applies, for example:

$$φ = \frac{m 1}{m 2} .$$

By actuating the expansion valve 15, for example, a first flow cross-section of the first expansion valve 15 through which the first partial mass flow can flow can be adjusted, i.e., changed. For example, the expansion valve 15 has a first actuator, in particular one that can be operated electrically, by means of which the first flow cross-section can be set. For example, the expansion valve 18 has a second flow cross-section through which the second partial mass flow can flow, which can be adjusted, i.e., changed, by actuating the expansion valve 18. For example, the expansion valve 18 has a second actuator, which can be operated electrically in particular, by means of which the second flow cross-section can be adjusted. The electronic computing device 19 controls the actuators, for example, as a function of the determined pressures and as a function of the determined temperatures, in order to thereby adjust the flow cross-sections and subsequently the partial mass flows and thus the mixing ratio φ.

In FIG. 1, a third point is designated as 3, wherein the third point 3 is also referred to as the third location. It can be seen that the third point 3 in the condenser section 12 is located downstream of the condenser 14 and upstream of the expansion valve 15. For example, the third temperature and the third pressure prevail at or in the third point 3. For example, the third sensor device S3 measures the third pressure and the third temperature at or in the third point 3. Furthermore, a fourth point is designated 4 in FIG. 1, wherein the fourth point is also referred to as the fourth location or is a fourth location. It can be seen that the fourth point, i.e., the fourth point 4, is located in the condenser section 12 downstream of the expansion valve 15 and upstream of the mixing point M. Furthermore, a fifth point is labeled 5 in FIG. 1, wherein the fifth point 5 is also referred to as the fifth point or is designed as the fifth point. It can be seen that the fifth point 5 is located in the bypass section 16 downstream of the expansion valve 18 and upstream of the mixing point M.

In order to be able to realize a particularly efficient operation of the temperature control device 6, the temperature control device 6 has a heat accumulator 17 designed to store heat, which is designed as a latent heat accumulator and thus has at least or exactly one phase change material for storing the heat. The heat accumulator 17 has an inlet region EB with at least or exactly two inlets, namely a first inlet E1 and a second inlet E2. Furthermore, the heat accumulator 17 has an outlet region AB with at least or exactly two outlets, namely a first outlet A1 and a second outlet A2. The refrigerant can be supplied to the thermal accumulator 17 via the inlet region EB, so that heat from the refrigerant supplied to the thermal accumulator 17 via the inlet region EB and flowing through the thermal accumulator 17 can be stored in the thermal accumulator 17 or heat from the thermal accumulator 17 can be transferred to the refrigerant supplied to the thermal accumulator 17 via the inlet region EB and flowing through the thermal accumulator 17. The refrigerant supplied to the thermal accumulator 17 via the inlet region EB can be discharged from the thermal accumulator 17 via the outlet region AB after it has passed through the thermal accumulator 17 and thereby flowed from the inlet region EB to the outlet region AB.

It can also be seen that four branches Z1, Z2, Z3 and Z4 through which the refrigerant can flow are assigned to the heat accumulator 17. The branches Z1 and Z3 are connected to the inlet region EB, i.e., fluidically connected to the inlet region EB, in this case in such a way that the branch Z1 is connected to the inlet E1 and the branch Z3 to the inlet E2. The branches Z2 and Z4 are connected to the outlet region AB, i.e., fluidically connected to the outlet region AB, in the present case in such a way that the branch Z2 is connected to the outlet A1 and the branch Z4 is connected to the outlet A2. This means that the refrigerant flowing through the branch Z1 can be fed to the inlet E1 via the branch Z1 and fed to the heat accumulator 17 via the inlet E1 and introduced into the heat accumulator 17. The refrigerant flowing through the branch Z3 is fed to the inlet E2 via the branch Z3 and fed to the heat accumulator 17 via the inlet E2 and introduced into the heat accumulator 17. After flowing through the heat accumulator 17 and flowing from the inlet E1 to the outlet A1, the refrigerant can be discharged from the heat accumulator 17 via the outlet A1 and introduced into the branch Z2, so that the refrigerant introduced into the branch Z2 can be discharged from the heat accumulator 17 via the branch Z2. After the refrigerant has passed through the heat accumulator 17 and has flowed from the inlet E2 to the outlet A2, it can be discharged from the heat accumulator 17 via the outlet A2 and introduced into the branch Z4, so that the refrigerant introduced into the branch Z4 can be discharged from the heat accumulator 17 via the branch Z4.

The temperature control device 1 also comprises a valve device 27, which in the present case has at least or exactly two valves, namely a first valve 28 and a second valve 29. In the exemplary embodiment shown in the figure, the respective valve 28, 29 is designed as a 3/2-way valve.

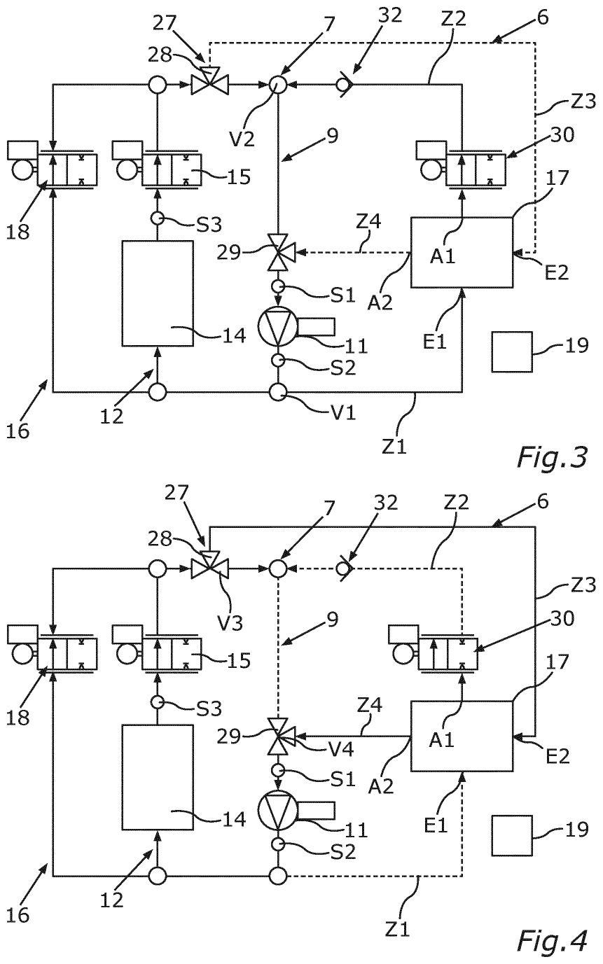

The valve device 27 can be switched between a first switching state shown in FIG. 3 and a second switching state shown in FIG. 4. In the first switching state, the heat accumulator 17 is connected to the refrigerant circuit 7 by means of the valve device 27 in such a way that in the first switching state the heat accumulator 17 is connected to a first connection point V1 arranged downstream of the refrigerant compressor 11, upstream of the condenser section 12 and upstream of the bypass section 16 in the refrigerant circuit 7, in particular in the compressor section 9, and to a second connection point V1 arranged upstream of the refrigerant compressor 11 in the refrigerant circuit 7, in particular in the compressor section 9, in particular in the compressor section 9, whereby at least one portion of the refrigerant compressed by means of the refrigerant compressor 11, in particular the compressor flow, can be fed to the heat accumulator 17 from the first connection point V1 via the inlet region EB and the refrigerant discharged from the heat accumulator 17 via the outlet region AB can be introduced into the refrigerant circuit 7 at the second connection point V2. The second connection point V2 is arranged downstream of the first expansion valve 15 and in the present case also downstream of the second expansion valve 18, wherein it is conceivable in principle that the connection point V2 coincides with the mixing point M. In the exemplary embodiment shown in FIG. 1, however, the connection point V2 is arranged downstream of the mixing point M. In the first switching state, at least some of the refrigerant compressed by the refrigerant compressor 11, in particular the compressor flow, can be fed to the thermal accumulator 17 from the first connection point V1 via the inlet region EB, in particular via the inlet E1, and in the first switching state, the refrigerant discharged from the thermal accumulator 17 via the outlet region AB, in particular via the outlet A1, can be fed into the refrigerant circuit 7 at the second connection point V2. It can be seen that, at least in the first switching state, the inlet E1 at the connection point V1 and the outlet A1 at the connection point V2 are fluidically connected to the refrigerant circuit 7, while the inlet E2 and the outlet A2 are fluidically separated from the refrigerant circuit 7, in particular by means of the valve device 27.

In the second switching state, the heat accumulator 17 is connected to the refrigerant circuit 7 by means of the valve device 27 in such a way that in the second switching state the heat accumulator 17 is connected to a third connection point V3 arranged upstream of the refrigerant compressor 11, which is arranged in the refrigerant circuit 7 downstream of the first expansion valve 15 and downstream of the second expansion valve 18, and at a fourth connection point V4 arranged downstream of the third connection point V3 and upstream of the refrigerant compressor 11 in the refrigerant circuit 7, in particular in the compressor section 9, and is fluidically connected to the refrigerant circuit 7 at a fourth connection point V4 arranged downstream of the third connection point V3 and upstream of the refrigerant compressor 11 in the refrigerant circuit 7, in particular in the compressor section 9, whereby in the second switching state at least one portion of the total mass flow, in particular the entire total mass flow, can be fed to the heat accumulator 17 from the third connection point V3 via the inlet region EB, in particular via the inlet E2, and the refrigerant discharged from the heat accumulator 17 via the outlet region AB, in particular the outlet A2, can be introduced into the refrigerant circuit 7, in particular into the compressor section 9, at the fourth connection point V4.

In principle, it would be conceivable for the third connection point V3 to coincide with the second connection point V2 and/or with the mixing point M. In the present case, however, it is envisaged that the third connection point V3 is arranged downstream of the mixing point M and in particular upstream of the second connection point V2. Furthermore, it would be conceivable that the connection point V3 is arranged upstream of the mixing point M and downstream of the expansion valve 18 in the bypass section 16, or it would be conceivable that the connection point V3 is arranged downstream of the expansion valve 15 and upstream of the mixing point M in the condenser section 12.

For example, in the first switching state, a third partial mass flow of refrigerant can be supplied to the heat accumulator 17 via inlet E1 from connection point V1. At the connection point V2, the third partial mass flow is introduced into the refrigerant circuit 7 and thereby mixed with the total mass flow, whereby the compressor flow comprises the total mass flow and the third partial mass flow and thus the first partial mass flow and the second partial mass flow and the third partial mass flow, in particular such that the compressor flow is formed exclusively by the first partial mass flow, the second partial mass flow and the third partial mass flow. Thus, for example, the third partial mass flow is the aforementioned further partial mass flow.

It can be seen that the branch Z1 is connected to the refrigerant circuit 7 at the connection point V1, the branch Z2 is connected to the connection point V2, the branch Z3 is connected to the connection point V3 and the branch Z4 is connected to the connection point V4, both in the first switching state and in the second switching state. In the first switching state, the inlet E1 is fluidically connected to the refrigerant circuit 7 via the branch Z1 at the connection point V1, and in the first switching state, the outlet A1 is fluidically connected to the refrigerant circuit 7 via the branch Z2 at the connection point V2. In the first switching state, the branch Z3 and thus the inlet E2 are fluidically isolated from the refrigerant circuit 7 by means of the valve device 27, in particular by means of the valve 28, and in the first switching state, the branch Z4 and thus the outlet A2 are fluidically isolated from the refrigerant circuit 7 by means of the valve device 27, in particular by means of the valve 29, in particular by means of the valve 29, are fluidically separated from the refrigerant circuit 7, so that in the first switching state no refrigerant can flow from the refrigerant circuit 7 from the connection point V3 via the heat accumulator 17 to the connection point V4 or vice versa.

In the second switching state, the inlet E2 is fluidically connected to the refrigerant circuit 7 via the branch Z3 and, in the present case, also via the valve device 27, in particular via the valve 28, at the connection point V3, and in the second switching state, the outlet A2 is fluidically connected to the refrigerant circuit 7 via the branch Z4 and, in the present case, also via the valve device 27, in particular the valve 29, at the connection point V4. In the second switching state, the branch Z2 and thus the outlet A1 are fluidically separated from the refrigerant circuit 7 by means of the valve device 27, in particular by means of the valve 28, so that in the second switching state no refrigerant can flow from the refrigerant circuit 7 from the connection point V1 via the heat accumulator 17 to the connection point V2 or vice versa.

FIG. 2 shows a phase diagram of the refrigerant designed as R1234yf, for example, wherein the phase diagram shown in FIG. 2 illustrates operation of the temperature control device 1 without the heat accumulator 17. As usual, the abscissa 20 of the phase diagram shows or indicates the enthalpy of the refrigerant, in particular the specific enthalpy, in particular in kilojoules per kilogram. As usual, the pressure of the refrigerant, in particular in bar, is plotted or indicated on the ordinate 21 of the phase diagram, for example logarithmically. The saturated vapor line of the refrigerant in the phase diagram is labeled 22. Points 1, 2, 3, 4 and 4 are entered in the phase diagram so that the respective enthalpy of the refrigerant at points 1, 2, 3, 4 and 5 can be recognized from the phase diagram shown in FIG. 2. In particular, it can be seen that the enthalpy of the refrigerant is the same at points 1, 4 and 5, and the enthalpy of the refrigerant is the same at points 2 and 3. In FIG. 2, an arrow 23 illustrates a change in state of the refrigerant from point 1 to point 2, and an arrow 24 illustrates a change in state of the refrigerant from point 2 to point 5. An arrow 25 illustrates a change in state of the refrigerant from point 2 to point 3, and an arrow 26 illustrates a change in state of the refrigerant from point 3 to point 4. The respective change in state is to be understood as a respective change in the thermodynamic state of the refrigerant. It can be seen that a first thermodynamic cycle process, which is designed as a first triangular process, takes place via points 1, 2, 3 and 4, i.e., via the compressor section 9 and the condenser section 12, and a second thermodynamic cycle process, which is designed as a second triangular process, takes place via points 1, 2 and 5, i.e., via the compressor section and the bypass section 16. The triangular processes, which are also simply referred to as processes, are parallel, wherein none of the triangular processes is self-contained. It is desirable for point 1 to lie stably to the right of the saturated vapor line 22 in relation to the phase diagram shown in FIG. 2. In other words, it is desirable that the first partial mass flow and the second partial mass flow and, in particular in the first switching state, preferably also the third partial mass flow and thus the mixing ratio or, in particular in the first switching state, an overall mixing ratio, according to which, in particular in the first switching state, the first partial mass flow and the second partial mass flow or the total mass flow and the third partial mass flow are mixed or blended with each other by means of the expansion valves 15 and 18 and, for example, also by means of a third expansion valve 30 in such a way that the enthalpy of the refrigerant at or in point 1 is adjusted in relation to the phase diagram shown in FIG. 2 is safe or stable to the right of the saturated vapor line 22. The previous and following remarks on the expansion valves 15 and 18 can also be applied to the expansion valve 30 without further ado. It can be seen that the temperature control device 1 has the third expansion valve 30, which in the first switching state is arranged downstream of the first connection point V1 and upstream of the second connection point V2 and thereby downstream of the heat accumulator 17 and upstream of the second connection point V2. By means of the third expansion valve 30, the third partial mass flow rate flowing through the heat accumulator 17 in the first switching state is or is adjusted, i.e., varied and thus changed. For example, the third expansion valve 30 has a third flow cross-section through which the third partial mass flow can flow, which can be adjusted, i.e., can be changed or varied, by controlling the expansion valve 30, which can be controlled or is controlled by means of the electronic computing device 19, in particular as a function of the determined pressures and as a function of the determined temperatures. For this purpose, for example, the third expansion valve 30 comprises a third actuator, in particular an electrically operable actuator, by means of which the third flow cross-section can be adjusted, i.e., changed, by activating the expansion valve 30. By adjusting the first partial mass flow, the second partial mass flow and the third partial mass flow, a total mass flow can be adjusted from the partial mass flows, i.e., from the first partial mass flow, the second partial mass flow and the third partial mass flow, in particular by that in the first switching state at the connection point V2, the third partial mass flow is introduced into the refrigerant circuit 7 and thus into the total mass flow, i.e., into the first partial mass flow and into the second partial mass flow, and is mixed with the first partial mass flow and with the second partial mass flow or the total mass flow. It is therefore desirable that the first partial mass flow, the second partial mass flow and the third partial mass flow and thus the mixing ratio and, very preferably, the total mixing ratio, also referred to as the total mixing ratio, are adjusted by means of the expansion valves 15, 18 and 30 in such a way that the enthalpy of the refrigerant at or in point 1, with reference to the phase diagram shown in FIG. 2, is safely or stably positioned to the right of the saturated vapor line 22. This can ensure that the compressor flow is at least predominantly, in particular exclusively, superheated vapor. In other words, this can prevent wet vapor or a liquid from flowing through the refrigerant compressor 11, which could lead to damage to the refrigerant compressor 11. Operating the temperature control device 6 in such a way that the enthalpy of the refrigerant at or in point 1 is safely to the right of the saturated vapor line 22 in relation to the phase diagram shown in FIG. 2 is also referred to as stabilizing stabilization.

FIG. 2 shows that the refrigerant has a first enthalpy at or in the first point 1, a second enthalpy at or in the second point, a third enthalpy at or in the third point 3, a fourth enthalpy at or in the fourth point 4 and a fifth enthalpy at or in the fifth point 5. The fourth enthalpy corresponds to the third enthalpy, and the fifth enthalpy corresponds to the second enthalpy. In addition, the refrigerant at or in points 1, 4 and 5, for example, has the same pressure, in particular the same first pressure. In FIG. 2, a sixth point 31 illustrates the enthalpy of the refrigerant belonging to the first pressure and lying on the saturated vapor line 22 of the refrigerant. The enthalpy of the refrigerant associated with the first pressure and lying on the saturated vapor line 22 of the refrigerant and illustrated by the point 31 is also referred to as the saturated vapor line enthalpy.

By using the heat accumulator 17 and by the fact that the heat accumulator 17 can optionally absorb heat from the refrigerant, in particular in the first switching state, or can release heat stored in the heat accumulator 17 to the refrigerant, in particular in the second switching state, the temperatures and thus the enthalpy of the refrigerant, for example, can be influenced, in particular changed, in a particularly demand-oriented and advantageous manner without having to operate the refrigerant compressor 11 excessively differently. In other words, the refrigerant compressor 11 can be operated at a particularly efficient operating point, in particular at the same efficient operating point, in order to be able to operate or supply the condenser with different capacities.

It can be seen from FIG. 1 that the temperature control device 6 has, for example, a non-return valve 32 which, in the first switching state, is arranged in series with the expansion valve 30 and in series with the heat accumulator 17 in such a way that the non-return valve 32 is arranged downstream of the expansion valve 30 or downstream of the heat accumulator 17 and upstream of the connection point V2. The non-return valve 32 is designed to close automatically in the direction of the heat accumulator 17 and thus automatically prevent a flow of the refrigerant from the connection point V2 through the non-return valve 32 to the heat accumulator 17. In addition, the non-return valve 32 is designed to open automatically in the direction of the connection point V2 and thus automatically allow a flow of the refrigerant from the heat accumulator 17 through the non-return valve 32 to the connection point V2. As a result, an undesired reverse flow of the refrigerant from the connection point V2 to the heat accumulator 17 can be avoided. Preferably, the refrigerant compressor 11 is an electric refrigerant compressor, which is also referred to as eKMV.

### LIST OF REFERENCE SIGNS

1 point
2 point
3 point
4 point
5 point
6 temperature control device
7 refrigerant circuit
9 compressor section
11 refrigerant compressor
12 condenser section
14 condenser
15 first expansion valve
16 bypass section
17 heat accumulator
18 second expansion valve
19 electronic computing device
20 abscissa
21 ordinate
22 saturated vapor line
23 arrow
24 arrow
25 arrow
26 arrow
27 valve device
28 valve
29 valve
30 expansion valve
31 point
32 non-return valve
AB outlet region
A1 outlet
A2 outlet
D1 enthalpy difference
D2 enthalpy difference
EB inlet region
E1 inlet
E2 inlet
A branch-off point
M mixing point
V1 first connection point
V2 second connection point
V3 third connection point
V4 fourth connection point
S1 sensor device
S2 sensor device
S3 sensor device
Z1 branch
Z2 branch
Z3 branch
Z4 branch

1-10. (canceled)

11. A temperature control device for controlling the temperature of at least one portion of a motor vehicle, comprising:
a refrigerant circuit through which a refrigerant flows, the refrigerant circuit comprising:
a compressor section through which the refrigerant can flow and in which a refrigerant compressor is configured to convey and compress the refrigerant;
a condenser section which is connected in series with the compressor section and through which a first partial mass flow of the refrigerant can flow and in which a first expansion valve is configured to adjust and expand the first partial mass flow, and a condenser configured to condense the first partial mass flow, are arranged;
a bypass section which is connected in parallel with the condenser section and in series with the compressor section and through which a second partial mass flow of the refrigerant can flow and in which a second expansion valve is arranged and configured to adjust and expand the second partial mass flow; and
a mixing point, at which the condenser section and the bypass section are brought together and the first partial mass flow and the second partial mass flow are brought together and mixed with one another to form a total mass flow;
a heat accumulator configured to store heat, comprising:
an inlet region, via which the refrigerant can be supplied to the heat accumulator, so that heat from the refrigerant supplied to the heat accumulator via the inlet region can be stored in the heat accumulator or heat from the heat accumulator can be transferred to the refrigerant supplied to the heat accumulator via the inlet region; and
an outlet region configured to discharge from the heat accumulator the refrigerant supplied to the heat accumulator via the inlet region; and
a valve device which configured to be switched between:
a first switching state, in which the heat accumulator is fluidically connected to the refrigerant circuit at a first connection point, which is arranged downstream of the refrigerant compressor, upstream of the condenser section and upstream of the bypass section in the refrigerant circuit, and at a second connection point, which is arranged upstream of the refrigerant compressor in the refrigerant circuit and which is arranged in the refrigerant circuit downstream of the first expansion valve and/or downstream of the second expansion valve, whereby at least one portion of the refrigerant compressed by the refrigerant compressor can be fed to the heat accumulator via the inlet region from the first connection point and the refrigerant discharged from the heat accumulator via the outlet region can be introduced into the refrigerant circuit at the second connection point; and
a second switching state, in which the heat accumulator is fluidically connected to the refrigerant circuit at a third connection point, which is arranged upstream of the refrigerant compressor in the refrigerant circuit and which is arranged in the refrigerant circuit downstream of the first expansion valve and/or downstream of the second expansion valve, and at a fourth connection point, which is arranged downstream of the third connection point and upstream of the refrigerant compressor in the refrigerant circuit, whereby at least one portion of the total mass flow can be fed to the heat accumulator via the inlet region from the third connection point and the refrigerant discharged from the heat accumulator via the outlet region can be introduced into the refrigerant circuit at the fourth connection point.

12. The temperature control device according to claim 11, wherein the heat accumulator is configured as a latent heat accumulator which has at least one phase change material for storing the heat.

13. The temperature control device according to claim 12, wherein the phase change material has a melting temperature which lies in a range from 50 degrees Celsius up to 90 degrees Celsius, inclusive in each case.

14. The temperature control device according to claim 13, wherein the melting temperature is in a range between 75 degrees Celsius and 90 degrees Celsius, inclusive in each case.

15. The temperature control device according to claim 14, wherein the melting temperature is in a range between 75 degrees Celsius and 80 degrees Celsius, inclusive in each case.

16. The temperature control device according to claim 13, wherein the melting temperature is in a range between 50 degrees Celsius and 80 degrees Celsius, inclusive in each case.

17. The temperature control device according to claim 11, wherein:
in the first switching state, a third expansion valve, by means of which a third partial mass flow of the refrigerant, which in the first switching state is supplied to the heat accumulator via the inlet region and flows through the heat accumulator, can be adjusted and expanded, is connected in series with the heat accumulator in such a way that, in the first switching state, the third expansion valve is arranged downstream of the first connection point and upstream of the second connection point.

18. The temperature control device according to claim 17, wherein:
in the first switching state the third expansion valve is connected in series with the heat accumulator in such a way that in the first switching state the third expansion valve is arranged downstream of the heat accumulator and upstream of the second connection point.

19. A method for operating a temperature control device according to claim 11.

20. A motor vehicle, comprising at least one temperature control device according to claim 11.
